(19) United States
(12) Patent Application Publication
(10) Pub. No.: US 2022/0240719 A1
(43) Pub. Date: Aug. 4, 2022

(54) Grill stove stand

(71) Applicant: Nelson Shen, ONGGUAN (CN)

(72) Inventor: Nelson Shen, ONGGUAN (CN)

(21) Appl. No.: 16/974,378

(22) Filed: Jan. 25, 2021

(51) Int. Cl. A47J 37/07

(52) U.S. Cl. CPC A47J 37/0786

(57) ABSTRACT

A grill stove stand contains: a body, a grilling pan, and a wind shield assembly. A gap is defined between the grilling pan and the body, and the body includes multiple fixing plates. An accommodation space is defined by the multiple fixing plates and the grilling pan, and the body further includes a holding plane. The wind shield assembly includes two stop elements and a barrier. A respective stop element has a covering zone received in the accommodation space and configured to shield the gap, a bending zone extending from a top of the first covering zone away from the body, and two first engagement sections. A respective first engagement section extends outward from a respective end of two ends of the respective stop element opposite to the bending zone and abuts against the holding plane so as to shield the gap.

### FIELD OF THE INVENTION

The present invention relates to a grill stove stand which is capable of shielding wind effectively.

### BACKGROUND OF THE INVENTION

A conventional gas grill stove contains a gap defined between a body and a grill pan so as to circulate wind and view fire. However, when the wind becomes strong, it flows into the gap to blow the fire.

To solve above-mentioned problem, an improved grill stove stand has been developed. The grill stove stand contains a hanging partition configured to shield the wind, and the hanging partition has a hook configured to hang the handing partition on a peripheral side of the grill pan, and the hanging partition further has a shield extension configured to shield the gap.

However, the hook contacts with the grill pan to contact heat to the grill pan.

Furthermore, the hook contacts with a barbecue clip and/or a frying spatula, thus dropping the barbecue clip and/or the frying spatula easily.

The present invention has arisen to mitigate and/or obviate the afore-described disadvantages.

### SUMMARY OF THE INVENTION

The primary aspect of the present invention is to provide a grill stove stand which contains the wind shield assembly fixed between the body and the grilling pan so as to shield the gap between the grilling pan and the body effectively.

Another aspect of the present invention is to provide a grill stove stand which contains the wind shield assembly not fixed on the grill stove directly so as to avoid conducting heat from the grill stove.

To obtain the above mentioned aspects, a grill stove stand provided by the present invention contains: a body, a grilling pan, and a wind shield assembly;

The grilling pan is disposed on a top of the body, and a gap is defined between the grilling pan and the body, the body includes multiple fixing plates arranged on two sides thereof, an accommodation space is defined by the multiple fixing plates and the grilling pan, and the body further includes a holding plane formed on a rear end thereof.

The wind shield assembly includes two stop elements fixed on two peripheral sides thereof, and the wind shield assembly includes a barrier mounted on a rear end thereof. A respective stop element has a covering zone received in the accommodation space and configured to shield the gap, a bending zone extending from a top of the first covering zone away from the body, and two first engagement sections. A respective first engagement section extends outward from a respective end of two ends of the respective stop element opposite to the bending zone and abuts against the holding plane so as to shield the gap.

Preferably, the respective stop element has multiple elongated receiving orifices defined in the bending zone.

Preferably, the barrier has a first extension, a second extension, a fixing orifice defined on an end of the first extension, a positioning tab extending from an end of the second extension and configured to connect with the fixing orifice.

Preferably, the barrier further has two abutting portions extending from a top and a bottom thereof.

Preferably, the respective stop element further has two second engagement sections extending from two sides thereof.

Thereby, the wind shield assembly is fixed between the body and the grilling pan so as to shield the gap between the grilling pan and the body effectively. Preferably, the wind shield assembly is not fixed on the grill stove stand directly so as to avoid conducting heat from the grill stove stand.

### BRIEF DESCRIPTION OF THE DRAWINGS

FIG. 1 is a perspective view showing the exploded components of a grill stove stand according to a preferred embodiment of the present invention.

FIG. 2 is a perspective view showing the exploded components of a portion C of FIG. 1.

FIG. 3 is a side plan view showing the assembly of a part of the grill stove stand according to the preferred embodiment of the present invention.

FIG. 4 is a perspective view showing the assembly of a part of the grill stove stand according to the preferred embodiment of the present invention.

FIG. 5 is a perspective view showing the exploded components of a part of the grill stove stand according to the preferred embodiment of the present invention.

FIG. 6 is a perspective view showing the assembly of the grill stove stand according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

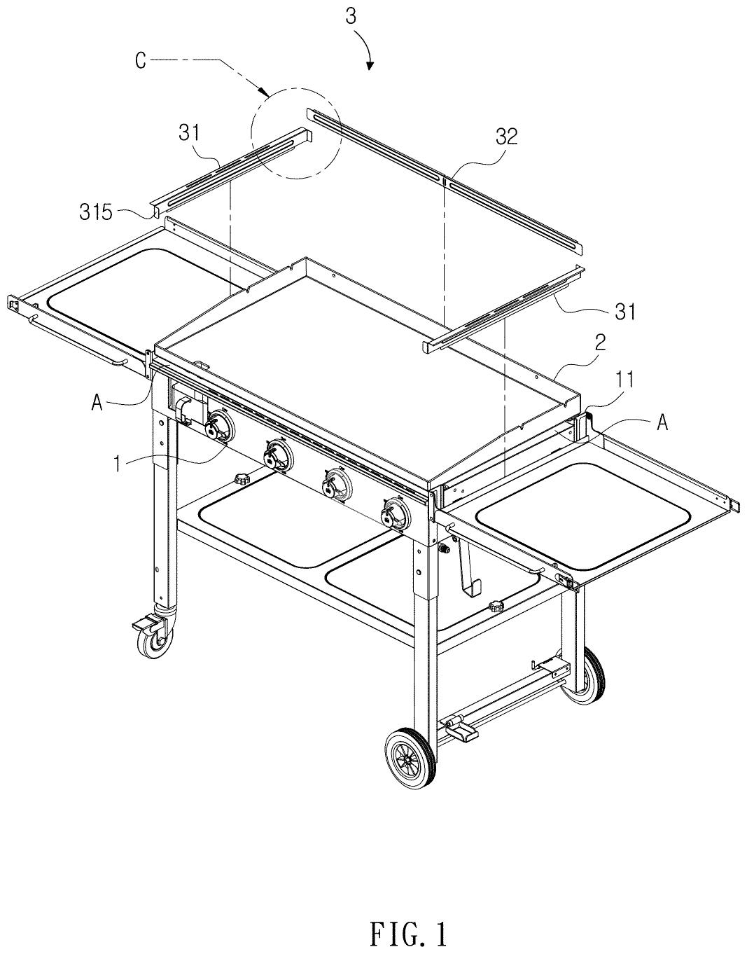

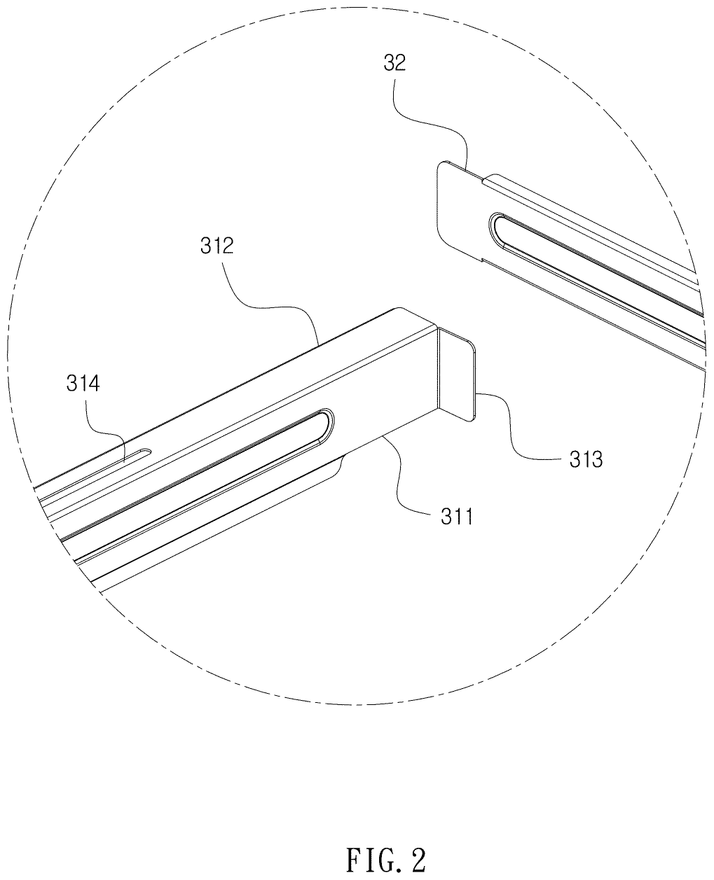

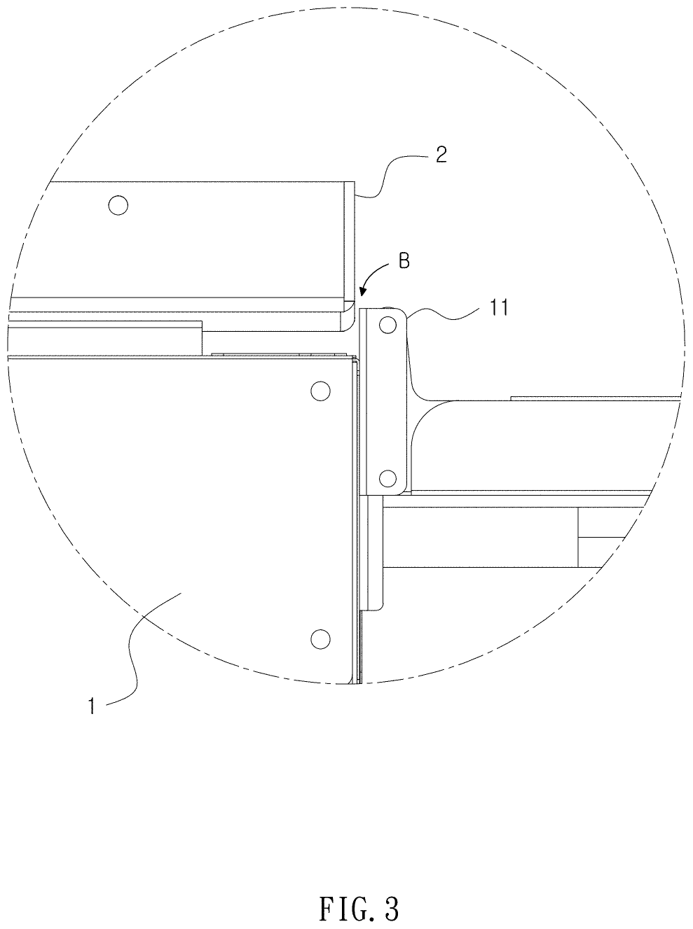

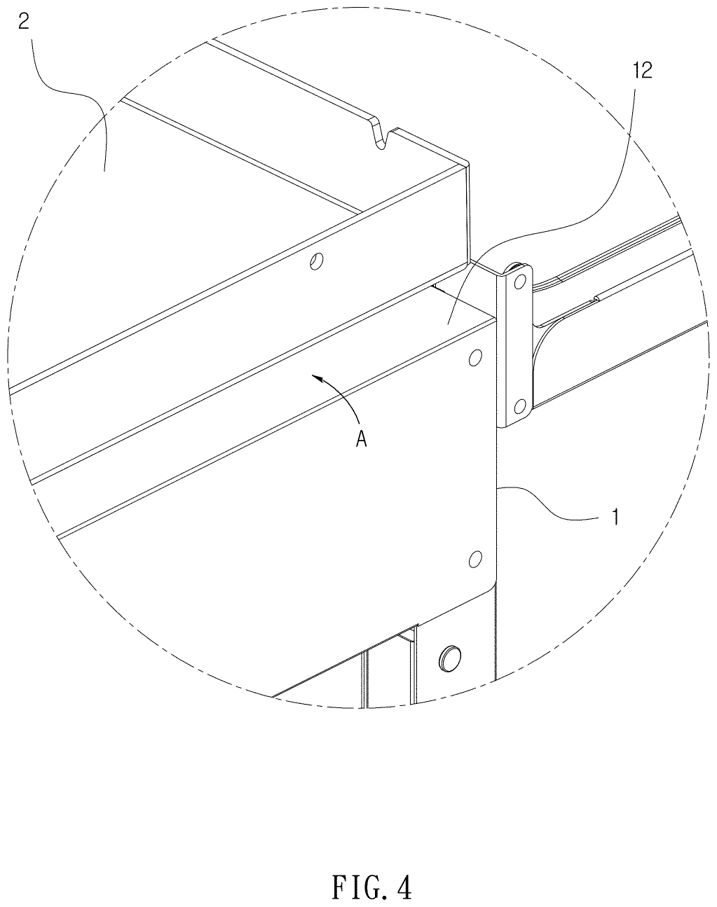

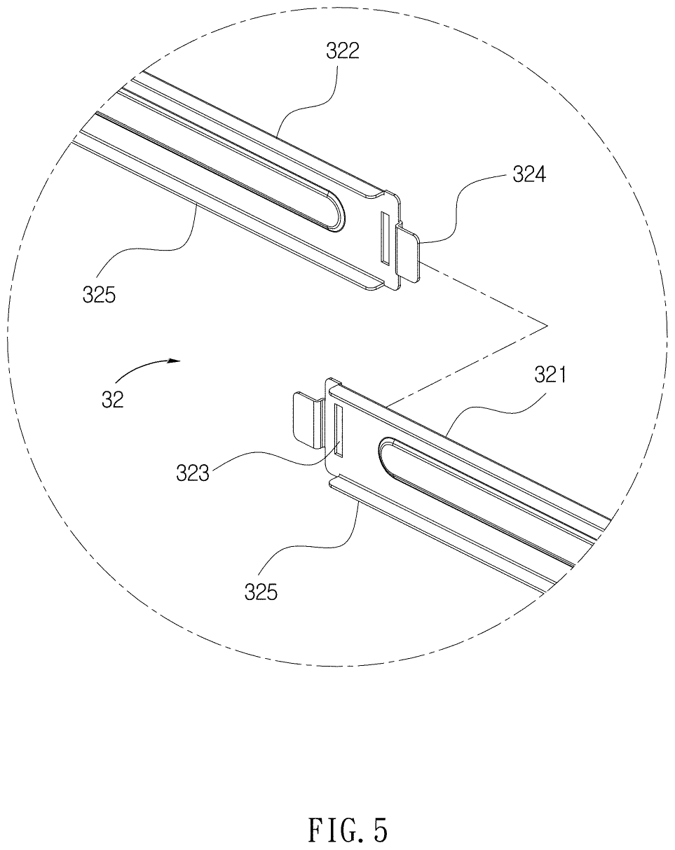

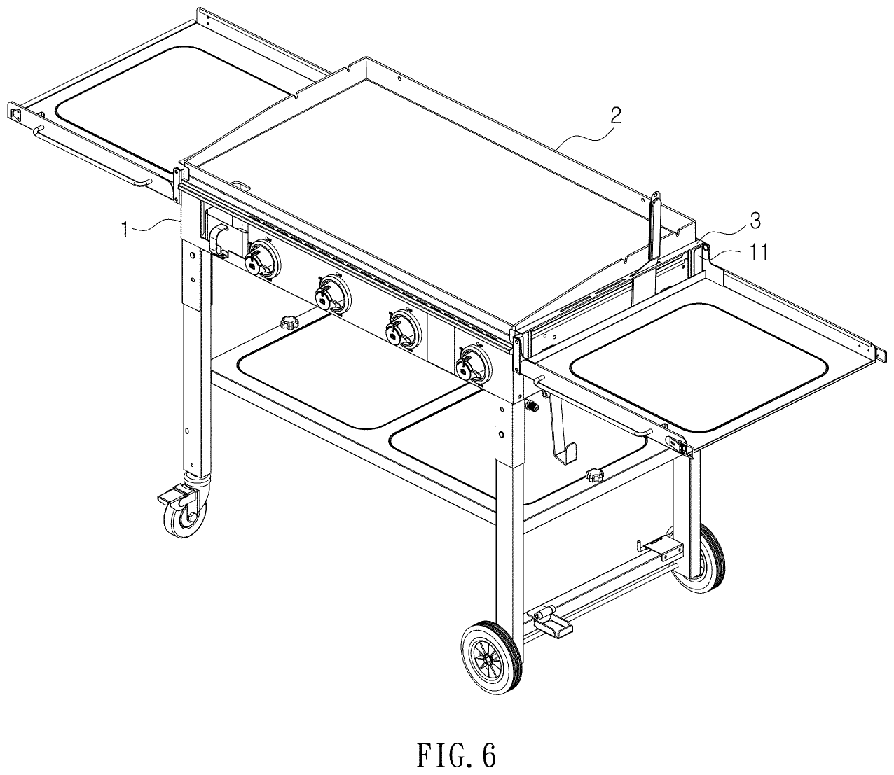

With reference to FIGS. 1-6, a grill stove stand according to a preferred embodiment of the present invention is capable of shielding wind effectively.

The grill stove stand comprises: a body 1, a grilling pan 2, and a wind shield assembly 3.

The grilling pan 2 is disposed on a top of the body 1, and a gap A is defined between the grilling pan 2 and the body 1. The body 1 includes multiple fixing plates 11 arranged on two sides thereof, an accommodation space B is defined by the multiple fixing plates 11 and the grilling pan 2, and the body 1 further includes a holding plane 12 formed on a rear end thereof.

The wind shield assembly 3 includes two stop elements 31 fixed on two peripheral sides thereof, and the wind shield assembly 3 includes a barrier 32 mounted on a rear end thereof, wherein a respective stop element 31 has a covering zone 311 received in the accommodation space B and configured to shield the gap A, a bending zone 312 extending from a top of the first covering zone 311 away from the body 1, and two first engagement sections 313, wherein a respective first engagement section 313 extends outward from a respective end of two ends of the respective stop element 31 opposite to the bending zone 312 and abuts against the holding plane 12 so as to shield the gap A.

Thereby, when the respective stop element 31 is received in the accommodation space B of the body 1 and the barrier 32 is fixed on the holding plane 12 of the body 1, a portion of the gap A among the body 1, two sides and a rear end of the grilling pan 2 are shielded by the respective first engagement section 313, and the other portion of the gap A between the body 1 and a front end of the grilling pan 2 is viewable by a user, thus shielding the wind effectively.

Preferably, the respective stop element 31 has multiple elongated receiving orifices 314 defined in the bending zone 312 and configured to accommodate a barbecue clip and/or a frying spatula.

Preferably, the barrier 32 has a first extension 321, a second extension 322, a fixing orifice 323 defined on an end of the first extension 321, a positioning tab 324 extending from an end of the second extension 322 and configured to connect with the fixing orifice 323, such that the barrier 32 is accommodated easily.

The barrier 32 further has two abutting portions 325 extending from a top and a bottom thereof and configured to abut against the holding plane 12.

The respective stop element 31 further has two second engagement sections 315 extending from two sides thereof and configured to engage with the body 1, wherein the two second engagement sections 315 and the two first engagement sections 313 of the respective stop element 31 engage with the body 1 so as to fix the wind shield assembly 3 on the body 1 securely.

Thereby, the wind shield assembly 3 is fixed between the body 1 and the grilling pan 2 so as to shield the gap between the grilling pan 2 and the body 1 effectively. Preferably, the wind shield assembly 3 is not fixed on the grill stove stand directly so as to avoid conducting heat from the grill stove stand.

While various embodiments in accordance with the present invention have been shown and described, it is clear to those skilled in the art that further embodiments may be made without departing from the scope of the present invention.

What is claimed is:

1. A grill stove stand comprising: a body, a grilling pan, and a wind shield assembly;
wherein the grilling pan is disposed on a top of the body, and a gap is defined between the grilling pan and the body, the body includes multiple fixing plates arranged on two sides thereof, an accommodation space is defined by the multiple fixing plates and the grilling pan, and the body further includes a holding plane formed on a rear end thereof;
wherein the wind shield assembly includes two stop elements fixed on two peripheral sides thereof, and the wind shield assembly includes a barrier mounted on a rear end thereof, wherein a respective stop element has a covering zone received in the accommodation space and configured to shield the gap, a bending zone extending from a top of the first covering zone away from the body, and two first engagement sections, wherein a respective first engagement section extends outward from a respective end of two ends of the respective stop element opposite to the bending zone and abuts against the holding plane so as to shield the gap.

2. The grill stove stand as claimed in claim 1, wherein the respective stop element has multiple elongated receiving orifices defined in the bending zone.

3. The grill stove stand as claimed in claim 1, wherein the barrier has a first extension, a second extension, a fixing orifice defined on an end of the first extension, a positioning tab extending from an end of the second extension and configured to connect with the fixing orifice.

4. The grill stove stand as claimed in claim 1, wherein the barrier further has two abutting portions extending from a top and a bottom thereof.

5. The grill stove stand as claimed in claim 1, wherein the respective stop element further has two second engagement sections extending from two sides thereof.
